(19) United States
(12) Patent Application Publication
(10) Pub. No.: US 2014/0163971 A1
(43) Pub. Date: Jun. 12, 2014

(54) METHOD OF USING A MOBILE DEVICE AS A MICROPHONE, METHOD OF AUDIO PLAYBACK, AND RELATED DEVICE AND SYSTEM

(71) Applicant: Tencent Technology (Shenzhen) Company Limited, Shenzhen (CN)

(72) Inventor: Bo SONG, Shenzhen (CN)

(73) Assignee: Tencent Technology (Shenzhen) Company Limited, Shenzhen (CN)

(21) Appl. No.: 14/095,808

(22) Filed: Dec. 3, 2013

Related U.S. Application Data
(63) Continuation of application No. PCT/CN2013/085346, filed on Oct. 16, 2013.

(30) Foreign Application Priority Data
Dec. 11, 2012 (CN) 201210530297.3

(51) Int. Cl. G10L 21/00

(52) U.S. Cl. CPC G10L 21/00
USPC 704/201

(57) ABSTRACT

The present disclosure discloses a method of using a mobile terminal as a microphone, an audio playback method, and related device and system. The method of using a mobile terminal as a microphone comprises: receiving identification information from a media device; establishing a data connection with the media device based on the identification information; converting a voice signal into audio data and sending the audio data to the media device, enabling the media device to output the audio data. According to the present disclosure, a mobile device and a media device can coordinate with each other. By connecting a mobile device, such as a mobile phone etc., with a media device, the mobile device can be used as a microphone. This makes it convenient for a user to use a microphone whenever and wherever, and meets the user's need.

### CROSS REFERENCE TO RELATED APPLICATION

This application is a U.S. continuation application under 35 U.S.C. §111(a) claiming priority, under 35 U.S.C. §120 and 365(c), to International Application No. PCT/CN2013/085346 filed on Oct. 16, 2013, which claims the priority benefit of Chinese Patent Application No. 201210530297.3, filed Dec. 11, 2012, the contents of both the PCT application and the Chinese application are incorporated by reference herein in their entirety for all purposes.

### TECHNICAL FIELD

The present disclosure relates generally to the technological field of multimedia, and more particularly, to a method of using a mobile device as a microphone, method of audio playback, and related device and system.

### BACKGROUND

The function of a microphone is to convert acoustical signals into electrical signals and to transmit the electrical signals to a media device so as to play them via one or more loudspeakers. A user's voice can be amplified via the aid of a microphone and a loudspeaker. This is especially convenient in public places. For example, in a karaoke bar, a user's sound of singing can be input into a microphone and amplified by a loudspeaker.

As an accessory to media devices, users do not generally carry a microphone with them. As a result, in certain circumstances such as during a public speech or in a karaoke bar, a shortage of microphones may occur either due to insufficient preparation or due to the relatively large number of speakers or singers. This causes huge inconvenience to users.

### SUMMARY OF THE DISCLOSURE

One of the technical problems to be solved by embodiments of the present disclosure is to provide a method of using a mobile device as a microphone, method of audio playback, and related device and system, so that the function of a microphone can be realized by such common mobile devices as mobile phones.

In order to solve the above technical problem, the present disclosure provides a method of using a mobile device as a microphone, the method comprising:

Receiving identification information from a media device;

Establishing a data connection with the media device based on the identification information;

Converting a voice signal into audio data and sending the audio data to the media device, enabling the media device to output the audio data.

Accordingly, the present disclosure provides an audio playback method comprising:

Sending identification information and establishing a data connection with a mobile device with microphone functionality activated based on a data connection request sent from the mobile device with microphone functionality activated based on the identification information;

Processing and outputting audio data when receiving the audio data from the mobile device with microphone functionality activated, wherein the audio data comprises a voice signal converted by the mobile device with microphone functionality activated.

Accordingly, the present disclosure provides a mobile device comprising:

A receiving module that receives identification information from a media device;

A connection establishing module that establishes a data connection with the media device based on the identification information; and

An output module that converts a voice signal into audio data and sends the audio data to the media device, enabling the media device to output the audio data.

Accordingly, the present disclosure provides a media device comprising:

A connection module that sends identification information and establishes a data connection with a mobile device with microphone functionality activated based on a data connection request sent from the mobile device with microphone functionality activated based on the identification information; and

A playback module that receives audio data from the mobile device with microphone functionality activated, processes and outputs the audio data, wherein the audio data comprises a voice signal converted by the mobile device with microphone functionality activated.

Accordingly, the present disclosure provides an audio playback system comprising at least one mobile device and at least one media device, wherein

The at least one mobile device receives identification information from a media device, establishes a data connection with the media device based on the identification information, converts a voice signal into audio data, and sends the audio data to the at least one media device; and

The at least one media device processes and outputs the audio data when receiving it from the at least one mobile device.

The present disclosure has the following beneficial effects:

By coordinating a mobile device and a media device, the mobile device (such as a mobile phone) that can be carried around can be used as a microphone. This not only expands the functionality of mobile devices such as mobile phones, but also cures the inconvenience to users caused by inadequate number of microphones, and allows users to conveniently use microphones whenever and wherever they want, thereby meeting the users' usage requirements.

### BRIEF DESCRIPTION OF THE DRAWINGS

FIG. 1 is a schematic diagram illustrating an example of the flow of a method of using a mobile device as a microphone according to various embodiments.

FIG. 2 is a schematic diagram illustrating an example of the flow of a method of using a mobile device as a microphone according to various embodiments.

FIG. 3 is a schematic diagram illustrating an example of the flow of an audio playback method according to various embodiments.

FIG. 4 is a schematic diagram illustrating an example of an arrangement of a mobile device according to various embodiments.

FIG. 5 is a schematic diagram illustrating an example of an arrangement of the output module in FIG. 4 according to various embodiments.

FIG. 6 is a schematic diagram illustrating an example of an arrangement of the output module in FIG. 4 according to various embodiments.

FIG. 7 is a schematic diagram illustrating an example of an arrangement of a media device according to various embodiments.

FIG. 8 is a schematic diagram illustrating an example of an arrangement of an audio playback system according to various embodiments.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

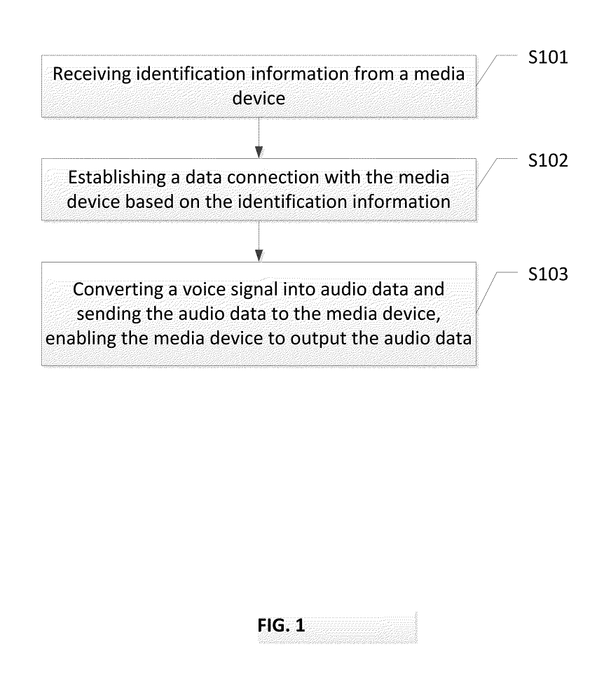

FIG. 1 is a schematic diagram illustrating an example of the flow of a method of using a mobile device as a microphone according to various embodiments. As used herein, a mobile device can be such device as a mobile phone or a tablet computer, etc. Examples of mobile devices include, but are not limited to, a tablet computer (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), a laptop computer (including, but not limited to, computers running Apple Mac operating system, Windows operating system, Android operating system and/or Google Chrome operating system), or an on-vehicle device running any of the above-mentioned operating systems or any other operating systems, or any other mobile Internet device (“MID”) or intelligent communication terminal, all of which are well known to those skilled in the art, as long as the mobile device supports audio input functionality. Examples of media devices include, but are not limited to, a jukebox, e.g., one in a karaoke bar, a personal computer, a smart television, or any audio/video playback device with such input functionality as Bluetooth, infrared, or WiFi. The method can comprise:

Step S101: receiving identification information from a media device.

According to some embodiments, the identification information can be received by a mobile device. According to some embodiments, the identification information can be the only identification information identifying the media device. Examples of the identification information include, but are not limited to, Bluetooth identification information and WiFi hotspot identification, etc.

Step S102: establishing a data connection with the media device based on the identification information.

According to some embodiments, a media device can periodically broadcast its own identification information, enabling mobile devices to access it. According to some embodiments, a media device can broadcast its identification information via an internal communication module such as a Bluetooth or an infrared communication module, enabling mobile devices with internal Bluetooth or infrared capability to establish Bluetooth or infrared connection with the media device based on the identification information. According to some other embodiments, a media device can be a media device with WiFi wireless communication capability and send its identification information to mobile devices with WiFi capability via a WiFi hotspot, enabling the mobile devices to establish data connections with the media device. According to yet some other embodiments, a media device can be a WiFi hotspot itself with WiFi capability, and send its identification information by broadcasting the identification information, enabling mobile devices to establish data connections with the media device.

According to some embodiments, a mobile device can receive identification information associated with one or more media devices in Step S101. According to these embodiments, the mobile device can select one or more media devices out of all the media devices identification information associated with which it has received and establish data connection(s) with each of the selected media device(s) respectively.

According to some embodiments, a mobile device and a media device can find each other under a same gateway and establish a data connection between themselves via a Universal Plug and Play (“UPnP”) protocol. This can also be achieved by adopting a user-defined multicast protocol, a user-defined TCP/IP data communication protocol, or some other streaming media protocol, all of which are well known to those skilled in the art.

Step S103: converting a voice signal into audio data and sending the audio data to the media device, enabling the media device to output the audio data.

According to some embodiments, a voice signal can be collected by a mobile device. According to some embodiments, converting a voice signal into audio data can comprise: performing pulse-code modulation (“PCM”) of the voice signal, thereby obtaining the audio data. According to some embodiments, a voice signal can be collected by the receiver of a mobile device such as a mobile phone, and then converted into PCM audio data and sent to a media device. One of the advantages of processing collected voice signals using PCM is that the amount of audio data thus obtained is relatively small. This can meet users' demand for high data transmission rate and real-time performance.

According to some embodiments, after a data connection between a mobile device and a media device has been established in Step S102, a user can send a message to one or more media devices from a mobile device using HTTP technology or multicast technology notifying each media device that the mobile device's microphone functionality has been activated, enabling the media devices to receive and play audio data. According to some embodiments, when a user no longer needs to use the microphone functionality of a mobile device such as a mobile phone, the mobile device can send a switch-off notification to one or more media devices, enabling the media devices to switch off relevant receiving function.

According to some embodiments, a media device can perform certain playback operation after receiving audio data. By way of example only, in situations such as speeches, a media device can analyze the audio data and output it to such sound amplifying devices as loudspeakers. In a karaoke bar, a media device can perform an audio mixing operation to mix received audio data with audio data associated with music currently to be played into a currently output audio stream before outputting the audio stream to a device such as a loudspeaker.

According to some embodiments, in order to reduce the amount of data being transmitted, after converting the voice signal into audio data in Step S103, the audio data can be compressed, and the compressed audio data can be sent to a media device. According to these embodiments, the media device can decompress the compressed audio data before outputting it.

From the above description, those skilled in the art will readily appreciate that the present disclosure has the following advantages:

By coordinating a mobile device and a media device, the mobile device (such as a mobile phone) that can be carried around can be used as a microphone. This not only expands the functionality of mobile devices such as mobile phones, but also cures the inconvenience to users caused by inadequate number of microphones, and allows users to conveniently use microphones whenever and wherever they want, thereby meeting the users' usage requirements. In certain situations not requiring real-time performance, audio data can be compressed before being sent to the media device, thereby reducing the amount of data being transmitted.

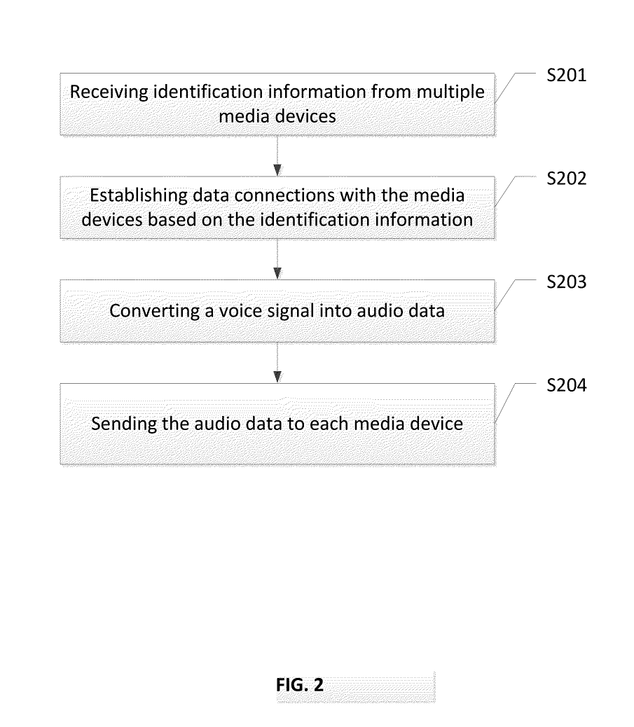

FIG. 2 is a schematic diagram illustrating an example of the flow of a method of using a mobile device as a microphone according to various embodiments. According to these embodiments, one mobile device can have data connections with multiple media devices. The method can comprise:

Step S201: receiving identification information from multiple media devices.

According to some embodiments, identification information sent from each media device can be separately received. According to some embodiments, data connection with each media device can be established separately based on their respective identification information. According to some embodiments, identification information from media devices can be saved for future use, e.g., to be transmitted later.

Step S202: establishing data connections with the media devices based on the identification information.

The process of establishing data connection with each of the media devices is the same as the process of establishing data connection with a media device as described above in connection with FIG. 1, and is not to be described herein in detail again.

Step S203: converting a voice signal into audio data.

According to some embodiments, the voice signal can be collected using the receiver of a mobile device such as a mobile phone. According to some embodiments, the voice signal can be converted to audio data in any format recognizable by a media device through which the audio data can be played, such as a PCM format.

Step S204: sending the audio data to each media device.

According to some embodiments, sending the audio data to each media device comprising sending the audio data to each media device by way of multicast based on the identification of each media device. According to some embodiments, the amount of audio data transmitted can be reduced by compressing the audio data before sending the audio data to each media device by multicast. According to these embodiments, each media device can decode and restore the audio data based on a compatible decompressing rule, and output the audio data to a corresponding loudspeaker or perform a mixing operation to mix the audio data into a currently output audio stream before outputting the audio stream to a loudspeaker.

From the above description, those skilled in the art will readily appreciate that the present disclosure has the following advantages:

By coordinating a mobile device and a media device, the mobile device (such as a mobile phone) that can be carried around can be used as a microphone. This not only expands the functionality of mobile devices such as mobile phones, but also cures the inconvenience to users caused by inadequate number of microphones, and allows users to conveniently use microphones whenever and wherever they want, thereby meeting the users' usage requirements.

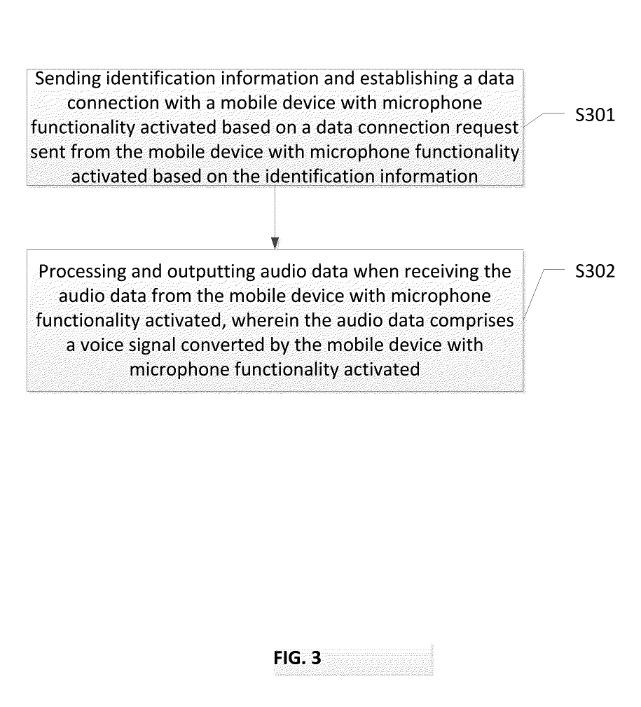

FIG. 3 is a schematic diagram illustrating an example of the flow of an audio playback method according to various embodiments. According to these embodiments, a media device can receive audio data from a mobile device such as a mobile phone used as a microphone and process the received audio data. The method can comprise:

Step S301: sending identification information and establishing a data connection with a mobile device with microphone functionality activated based on a data connection request sent from the mobile device with microphone functionality activated based on the identification information. As used herein, a mobile device with microphone functionality activated can be such device as a mobile phone or a tablet computer, etc., with microphone functionality.

According to some embodiments, a media device can periodically broadcast its own identification information, enabling mobile devices to access it. According to some embodiments, a media device can broadcast its identification information via an internal communication module such as a Bluetooth or an infrared communication module, enabling mobile devices with internal Bluetooth or infrared capability to establish Bluetooth or infrared connection with the media device based on the identification information. According to some other embodiments, a media device can be a media device with WiFi wireless communication capability and send its identification information to mobile devices with WiFi capability via a WiFi hotspot, enabling the mobile devices to establish data connections with the media device. According to yet some other embodiments, a media device can be a WiFi hotspot itself with WiFi capability, and send its identification information by broadcasting the identification information, enabling mobile devices to establish data connections with the media device.

According to some embodiments, a mobile device and a media device can find each other under a same gateway and establish a data connection between themselves via a UPnP protocol. This can also be achieved by adopting a user-defined multicast protocol, a user-defined TCP/IP data communication protocol, or some other streaming media protocol, all of which are well known to those skilled in the art.

Step S302: processing and outputting audio data when receiving the audio data from the mobile device with microphone functionality activated, wherein the audio data comprises a voice signal converted by the mobile device with microphone functionality activated.

According to some embodiments, a media device can perform certain playback operation after receiving audio data. By way of example only, in situations such as speeches, a media device can analyze the audio data and output it to such sound amplifying devices as loudspeakers. In a karaoke bar, a media device can perform an audio mixing operation to mix received audio data into a currently output audio stream before outputting the audio stream to a device such as a loudspeaker.

According to some embodiments, before Step S302, the audio data receiving function of a media device can be at an “off” status. According to these embodiments, after a data connection between a mobile device and the media device has been established, a user can send a message to one or more media devices from the mobile device using HTTP technology or multicast technology notifying each media device that the mobile device's microphone functionality has been activated, enabling the media devices to switch on receiving function to receive audio data and to play the audio data. According to some embodiments, after Step S302, if a user no longer needs to use the microphone functionality of a mobile device such as a mobile phone, the mobile device can send a switch-off notification to one or more media devices, enabling the media devices to switch off relevant receiving function after receiving the switch-off notification.

According to some embodiments, if the audio data received by a media device comprises compressed audio data, the media device can first decompress the audio data using a decompression method compatible with the mobile device before outputting and playing the audio data.

From the above description, those skilled in the art will readily appreciate that the present disclosure has the following advantages:

By coordinating a mobile device and a media device, the mobile device (such as a mobile phone) that can be carried around can be used as a microphone. This not only expands the functionality of mobile devices such as mobile phones, but also cures the inconvenience to users caused by inadequate number of microphones, and allows users to conveniently use microphones whenever and wherever they want, thereby meeting the users' usage requirements.

The following describes a mobile device, a media device, and an audio playback system according to various embodiments in detail.

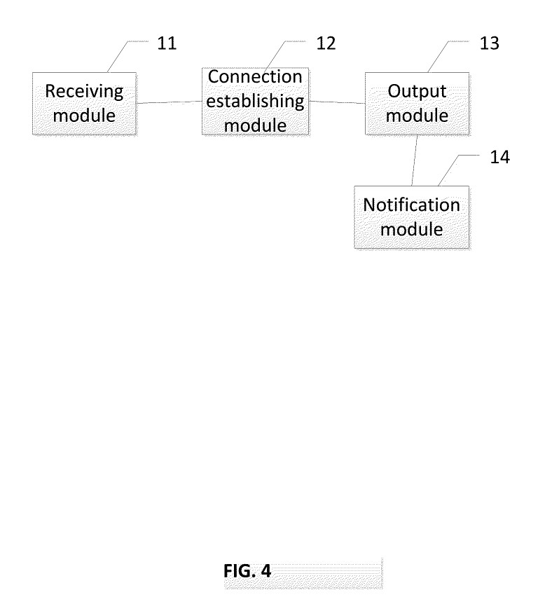

FIG. 4 is a schematic diagram illustrating an example of an arrangement of a mobile device according to various embodiments. According to these embodiments, a mobile device can be a device such as a mobile phone or a tablet computer comprising an voice signal collecting module such as a receiver. The mobile device can comprise:

A receiving module 11 that receives identification information from a media device.

A connection establishing module 12 that establishes a data connection with the media device based on the identification information.

An output module 13 that converts a voice signal into audio data and sends the audio data to the media device, enabling the media device to output the audio data.

According to some embodiments, a mobile device can receive via its receiving module 11 the only identification information identifying a media device from the media device. Examples of the identification information include, but are not limited to, Bluetooth identification information and WiFi hotspot identification, etc. This enables the mobile device's access to the media device.

According to some embodiments, a media device can periodically broadcast its own identification information, enabling mobile devices to access it. According to some embodiments, a media device can broadcast its identification information via an internal communication module such as a Bluetooth or an infrared communication module, enabling mobile devices with internal Bluetooth or infrared capability to establish Bluetooth or infrared connection with the media device based on the identification information. According to some other embodiments, a media device can be a media device with WiFi wireless communication capability and send its identification information to mobile devices with WiFi capability via a WiFi hotspot, enabling the mobile devices to establish data connections with the media device. According to yet some other embodiments, a media device can be a WiFi hotspot itself with WiFi capability, and send its identification information by broadcasting the identification information, enabling mobile devices to establish data connections with the media device.

According to some embodiments, a mobile device can receive identification information associated with one or more media devices via the receiving module 11. According to these embodiments, the mobile device can select one or more media devices out of all the media devices identification information associated with which it has received and establish data connection(s) with each of the selected media device(s) respectively via the connection establishing module 12.

According to some embodiments, a mobile device and a media device can find each other under a same gateway and establish a data connection between themselves via a UPnP protocol. This can also be achieved by adopting a user-defined multicast protocol, a user-defined TCP/IP data communication protocol, or some other streaming media protocol, all of which are well known to those skilled in the art.

According to some embodiments, a voice signal of a user can be collected by a receiver of a mobile device such as a mobile phone. According to some embodiments, the output module 13 can convert the voice signal into PCM audio data before sending the audio data to a media device.

According to some embodiments, a media device can perform certain playback operation after receiving audio data. By way of example only, in situations such as speeches, a media device can analyze the audio data and output it to such sound amplifying devices as loudspeakers. In a karaoke bar, a media device can perform an audio mixing operation to mix received audio data into a currently output audio stream before outputting the audio stream to a device such as a loudspeaker.

According to some embodiments, when there is more than one media device, the output module 13 can send audio data to each media device by way of multicast based on the identification of each media device.

Referring to FIG. 4 again, the mobile device can further comprise:

A notification module 14 that sends a message to the media device notifying the media device to receive and output the audio data.

According to some embodiments, after the connection establishing module 12 establishes a data connection between a mobile device and a media device, a user can send a message to one or more media devices via the notification module 14 of the mobile device using HTTP technology or multicast technology notifying each media device that the mobile device's microphone functionality has been activated, enabling the media devices to receive and play audio data. According to some embodiments, when a user no longer needs to use the microphone functionality of a mobile device such as a mobile phone, the mobile device can send a switch-off notification to one or more media devices, enabling the media devices to switch off relevant receiving function.

According to some embodiments, in order to reduce the amount of data being transmitted, after converting a voice signal into audio data, the output module 13 can compress the audio data, and send the compressed audio data to a media device. According to these embodiments, the media device can decompress the compressed audio data before outputting it.

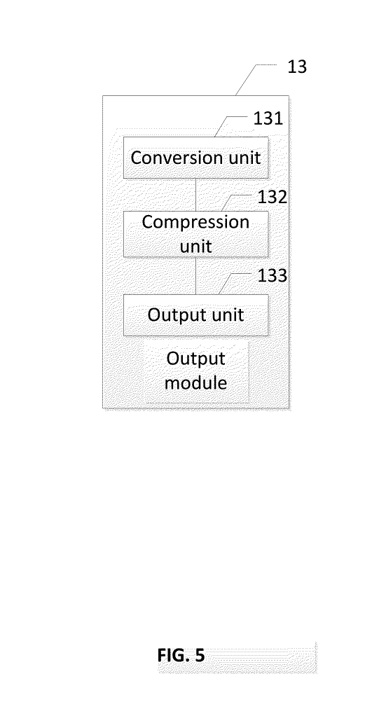

FIG. 5 is a schematic diagram illustrating an example of an arrangement of the output module in FIG. 4 according to various embodiments. The output module 13 can comprise:

A conversion unit 131 that converts a voice signal into audio data; and

An output unit 133 that sends the audio data to a media device, enabling the media device to output the audio data.

According to some embodiments, the conversion unit 131 can convert a voice signal and encode it into audio data with specified format. According to these embodiments, the media device can perform corresponding audio decoding and output the decoded audio data to a device such as a loudspeaker to play the corresponding audio data.

According to some embodiments, when there is more than one media device, the output unit 133 can send audio data to each media device by way of multicast based on the identification of each media device. According to some embodiments, in certain situations, e.g., when the bandwidth is small, audio data obtained from the conversion unit 131 can be compressed before being sent in order to reduce the amount of data being transmitted. According to these embodiments, the output module 13 can further comprise a compression unit 132 that compresses audio data obtained from the conversion unit 131.

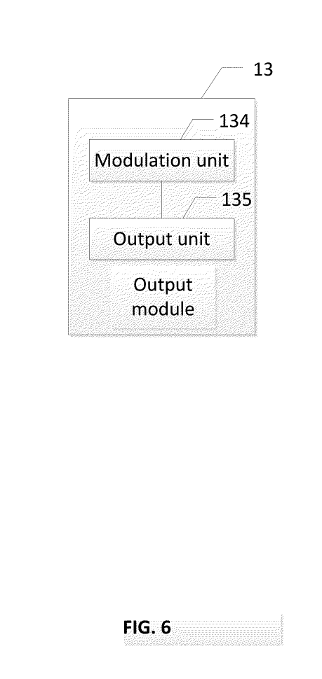

FIG. 6 is a schematic diagram illustrating another example of an arrangement of the output module in FIG. 4 according to various embodiments. The output module 13 can comprise:

A modulation unit 134 that performs PCM of a voice signal, thereby obtaining audio data; and

An output unit 135 that sends the audio data to a media device, enabling the media device to output the audio data.

One of the advantages of processing voice signals using PCM by the modulation unit 134 is that the amount of audio data thus obtained and output is relatively small. This can meet users' demand for high data transmission rate and real-time performance.

According to some embodiments, the output module 13 of a mobile device can comprise the conversion unit 131, the compression unit 132, the output unit 133, the modulation unit 134, and the output unit 135. This makes it convenient for the mobile device to switch between functions based on a user's need, thereby accomplishing different processing and outputting methods in connection with different audio data.

From the above description, those skilled in the art will readily appreciate that the present disclosure has the following advantages:

By coordinating a mobile device and a media device, the mobile device (such as a mobile phone) that can be carried around can be used as a microphone. This not only expands the functionality of mobile devices such as mobile phones, but also cures the inconvenience to users caused by inadequate number of microphones, and allows users to conveniently use microphones whenever and wherever they want, thereby meeting the users' usage requirements.

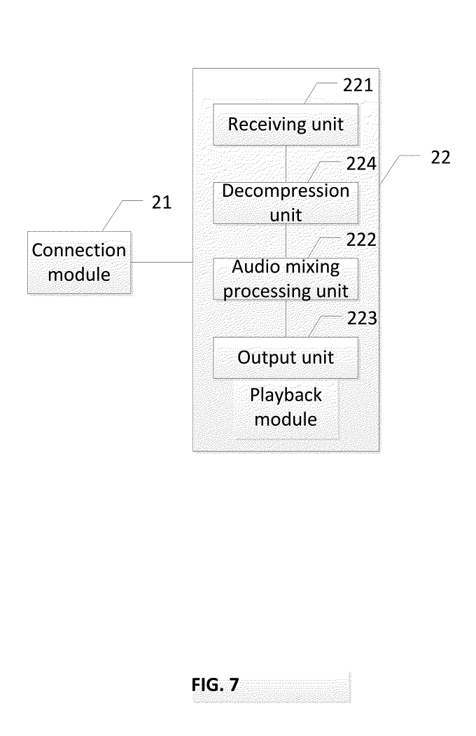

FIG. 7 is a schematic diagram illustrating an example of an arrangement of a media device according to various embodiments. Examples of media devices include, but are not limited to, a jukebox, e.g., one in a karaoke bar, a personal computer, a smart television, or any audio/video playback device. The media device can comprise:

A connection module 21 that sends identification information and establishes a data connection with a mobile device with microphone functionality activated based on a data connection request sent from the mobile device with microphone functionality activated based on the identification information.

A playback module 22 that receives audio data from the mobile device with microphone functionality activated, processes and outputs the audio data, wherein the audio data comprises a voice signal converted by the mobile device with microphone functionality activated.

According to some embodiments, a media device can periodically broadcast its own identification information via the connection module 21, enabling mobile devices to access it. According to some embodiments, the connection module 21 can broadcast the media device's identification information via an internal communication module such as a Bluetooth or an infrared communication module, enabling mobile devices with internal Bluetooth or infrared capability to establish Bluetooth or infrared connection with the media device based on the identification information. According to some other embodiments, a media device can be a media device with WiFi wireless communication capability. According to these embodiments, the connection module 21 can send the media device's identification information to mobile devices with WiFi capability via a WiFi hotspot, enabling the mobile devices to establish data connections with the media device. According to yet some other embodiments, a media device can be a WiFi hotspot itself with WiFi capability. According to these embodiments, the media device can send its identification information by broadcasting the identification information via the connection module 21, enabling mobile devices to establish data connections with the media device.

According to some embodiments, a mobile device and a media device can find each other under a same gateway and establish a data connection between themselves via a UPnP protocol. This can also be achieved by adopting a user-defined multicast protocol, a user-defined TCP/IP data communication protocol, or some other streaming media protocol, all of which are well known to those skilled in the art.

According to some embodiments, a media device can perform certain playback operation after the playback module 22 receives audio data. By way of example only, in situations such as speeches, a media device can analyze the audio data and output it to such sound amplifying devices as loudspeakers. In a karaoke bar, a media device can perform an audio mixing operation to mix received audio data into a currently output audio stream before outputting the audio stream to a device such as a loudspeaker.

According to some embodiments, before the playback module 22 outputs and plays audio data, the audio data receiving function of a media device can be at an “off” status. According to these embodiments, after a data connection between a mobile device and the media device has been established, a user can send a message to one or more media devices from the mobile device using HTTP technology or multicast technology notifying each media device that the mobile device's microphone functionality has been activated, enabling the media devices to switch on receiving function to receive audio data and to play the audio data. According to some embodiments, after the playback module 22 outputs and plays the audio data, if a user no longer needs to use the microphone functionality of a mobile device such as a mobile phone, the mobile device can send a switch-off notification to one or more media devices, enabling the media devices to switch off relevant receiving function after receiving the switch-off notification.

According to some embodiments, if the audio data received by a media device comprises compressed audio data, the playback module 22 of the media device can first decompress the audio data using a decompression method compatible with the mobile device before outputting and playing the audio data.

According to some embodiments, the playback module 22 can comprise:

A receiving unit 221 that receives audio data from a mobile device with microphone functionality activated;

An audio mixing processing unit 222 that mixes the audio data received by the receiving unit 221 with audio data currently to be played into a currently output audio stream; and

An output unit 223 that outputs the audio data.

Optionally, the playback module 22 can comprise a decompression unit 224 that performs decompression operation on compressed audio data when detecting that the audio data received by the receiving unit 221 comprises compressed audio data, and outputs the decompressed audio data to the audio mixing processing unit 222.

From the above description, those skilled in the art will readily appreciate that the present disclosure has the following advantages:

By coordinating a mobile device and a media device, the mobile device (such as a mobile phone) that can be carried around can be used as a microphone. This not only expands the functionality of mobile devices such as mobile phones, but also cures the inconvenience to users caused by inadequate number of microphones, and allows users to conveniently use microphones whenever and wherever they want, thereby meeting the users' usage requirements.

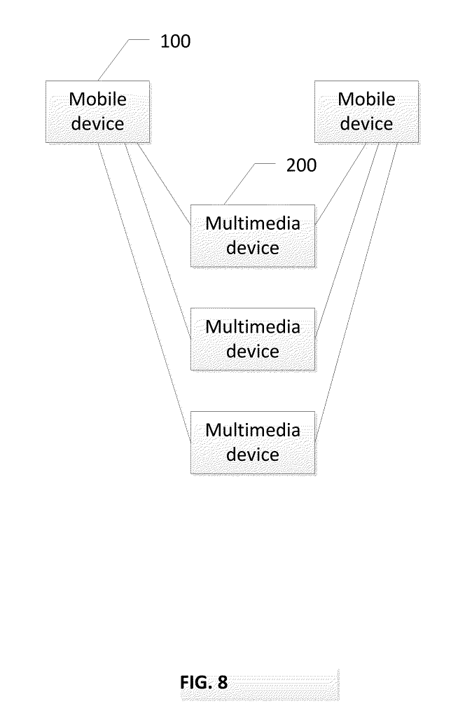

FIG. 8 is a schematic diagram illustrating an example of an arrangement of an audio playback system according to various embodiments. The audio playback system can comprise at least one mobile device, exemplified by mobile device 100 as illustrated in FIG. 8, and at least one media device, exemplified by media device 200 as illustrated in FIG. 8.

The mobile device 100 receives identification information from a media device, establishes a data connection with the media device based on the identification information, converts a voice signal into audio data, and sends the audio data to the at least media device; and

The media device 200 receives audio data from a mobile device with microphone functionality activated, processes and outputs the audio data, i.e., outputs the audio data to an existing loudspeaker device.

According to some embodiments, the mobile device 100 comprises a mobile device illustrated in FIG. 4 or FIG. 5. According to some embodiments, the media device 200 comprises a media device illustrated in FIG. 7.

According to some embodiments, the media device 200 can periodically broadcast its own identification information, enabling the mobile device 100 to access it. According to some embodiments, the media device 200 can broadcast its own identification information via an internal communication module such as a Bluetooth or an infrared communication module, enabling the mobile device 100 with internal Bluetooth or infrared capability to establish Bluetooth or infrared connection with the media device based on the identification information. According to some other embodiments, the media device 200 can be a media device with WiFi wireless communication capability, and can send its identification information to mobile device 100 with WiFi capability via a WiFi hotspot, enabling the mobile device 100 to establish a data connection with the media device 200. According to yet some other embodiments, the media device 200 can be a WiFi hotspot itself with WiFi capability, and can send its identification information by broadcasting the identification information, enabling the mobile device 100 to establish a data connection with the media device.

According to some embodiments, the mobile device 100 can receive identification information associated with one or more media devices. According to these embodiments, the mobile device 100 can select one or more media devices out of all the media devices identification information associated with which it has received and establish data connection(s) with each of the selected media device(s) respectively.

According to some embodiments, the mobile device 100 and the media device 200 can find each other under a same gateway and establish a data connection between themselves via a UPnP protocol. This can also be achieved by adopting a user-defined multicast protocol, a user-defined TCP/IP data communication protocol, or some other streaming media protocol, all of which are well known to those skilled in the art.

According to some embodiments, a voice signal of a user can be collected by a receiver of a mobile device such as a mobile phone, and converted into PCM audio data before the audio data is sent to a media device.

According to some embodiments, after a data connection between the mobile device 100 and the media device 200 has been established, a user can send a message to one or more media devices 200 from the mobile device 100 using HTTP technology or multicast technology notifying each media device 200 that the mobile device's microphone functionality has been activated, enabling the media devices 200 to receive and play the audio data. According to some embodiments, when a user no longer needs to use the microphone functionality of the mobile device 100 such as a mobile phone, the mobile device 100 can send a switch-off notification to one or more media devices 200, enabling the media devices 200 to switch off relevant receiving function.

According to some embodiments, the media device 200 can perform certain playback operation after it receives audio data. By way of example only, in situations such as speeches, the media device 200 can analyze the audio data and output it to such sound amplifying devices as loudspeakers. In a karaoke bar, the media device 200 can perform an audio mixing operation to mix received audio data into a currently output audio stream before outputting the audio stream to a device such as a loudspeaker.

From the above description, those skilled in the art will readily appreciate that the present disclosure has the following advantages:

By coordinating a mobile device and a media device, the mobile device (such as a mobile phone) that can be carried around can be used as a microphone. This not only expands the functionality of mobile devices such as mobile phones, but also cures the inconvenience to users caused by inadequate number of microphones, and allows users to conveniently use microphones whenever and wherever they want, thereby meeting the users' usage requirements.

Persons of ordinary skill in the art can readily appreciate that all or part of the steps of the methods described in the embodiments above can be executed by relevant hardware instructed by a program that may be stored in a computer-readable memory medium. The readable memory medium may be, for example, a read-only memory (“ROM”), a random access memory (“RAM”), a magnetic disk or a compact disc.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A method of using a mobile device as a microphone, comprising:
receiving identification information from a media device,
establishing a data connection with the media device based on the identification information,
converting a voice signal into audio data, and
sending the audio data to the media device, enabling the media device to output the audio data.

2. The method of claim 1, wherein converting the voice signal into audio data comprises:
performing pulse-code modulation of the voice signal.

3. The method of claim 1, comprising:
compressing the audio data, and
wherein sending the audio data to the media device comprises sending the compressed audio data to the media device.

4. The method of claim 1, comprising:
sending a message to the media device notifying the media device to receive and output the audio data.

5. The method of claim 1, wherein
receiving identification information from the media device comprises receiving identification information from multiple media devices,
establishing the data connection with the media device based on the identification information comprises establishing a data connection with the multiple media devices, and
sending the audio data to the media device comprises sending the audio data to the multiple media devices.

6. The method of claim 1, wherein the data connection with the media device is established via a protocol comprising at least one of a Universal Plug and Play protocol, a user-defined multicast protocol, and a user-defined TCP/IP data communication protocol.

7. An audio playback method comprising:
sending identification information to a mobile device,
receiving a data connection request from the mobile device, wherein the data connection request is sent from the mobile device based on the identification information,
establishing a data connection with the mobile device based on the data connection request,
receiving audio data from the mobile device, and
processing and outputting the audio data,
wherein the audio data comprises a voice signal converted by the mobile device.

8. The method of claim 7, wherein processing and outputting the audio data comprises:
performing an audio mixing operation to mix the audio data with audio data currently to be played into a currently output audio stream, and
outputting the audio stream.

9. The method of claim 7, wherein the data connection with the mobile device is established via a protocol comprising at least one of a Universal Plug and Play protocol, a user-defined multicast protocol, and a user-defined TCP/IP data communication protocol.

10. A mobile device comprising:
a receiving module that receives identification information from a media device,
a connection establishing module that establishes a data connection with the media device based on the identification information, and
an output module that converts a voice signal into audio data and sends the audio data to the media device, enabling the media device to output the audio data.

11. The mobile device of claim 10, comprising at least one of a mobile phone and a tablet computer.

12. The mobile device of claim 10, comprising:
a notification module that sends a message to the media device notifying the media device to receive and output the audio data.

13. The mobile device of claim 10, wherein the output module comprises:
a modulation unit that performs pulse-code modulation of the voice signal to obtain the audio data, and
an output unit that sends the audio data to the media device.

14. The mobile device of claim 10, wherein the output module comprises:
a conversion unit that converts the voice signal into the audio data,
a compression unit that compresses the audio data, and
an output unit that sends the compressed audio data to the media device.

15. The mobile device of claim 10, wherein
the receiving module receives identification information from multiple media devices,
the connection establishing module establishes a data connection with the multiple media devices, and
the output module sends the audio data to the multiple media devices.

16. The mobile device of claim 10, wherein the connection establishing module establishes the data connection with the media device via a protocol comprising at least one of a Universal Plug and Play protocol, a user-defined multicast protocol, and a user-defined TCP/IP data communication protocol.

17. A media device comprising:
a connection module that sends identification information to a mobile device, receives a data connection request from the mobile device based on the identification information, and establishes a data connection with the mobile device based on the data connection request, wherein the data connection request is sent from the mobile device to the media device based on the identification information, and
a playback module that receives audio data from the mobile device, and processes and outputs the audio data, wherein the audio data comprises a voice signal converted by the mobile device.

18. The media device of claim 17, comprising at least one of a jukebox, a personal computer, and a smart television.

19. The media device of claim 17, wherein the playback module comprises:
a receiving unit that receives the audio data from the mobile device,
an audio mixing processing unit that performs an audio mixing operation to mix the audio data with audio data currently to be played into a currently output audio stream, and
an output unit that outputs the audio stream.

20. The media device of claim 17, wherein the connection module establishes the data connection with the mobile device via a protocol comprising at least one of a Universal Plug and Play protocol, a user-defined multicast protocol, and a user-defined TCP/IP data communication protocol.
